(19) United States
(12) Patent Application Publication
(10) Pub. No.: US 2026/0058597 A1
(43) Pub. Date: Feb. 26, 2026

(54) STORMPROOF PHOTOVOLTAIC SYSTEM

(71) Applicant: Hermann KOPETZ, Krumpendorf (AT)

(72) Inventor: Hermann KOPETZ, Krumpendorf (AT)

(21) Appl. No.: 18/862,974

(22) PCT Filed: Dec. 21, 2022
(86) PCT No.: PCT/AT2022/060455

§ 371 Date: Nov. 5, 2024

(30) Foreign Application Priority Data
May 5, 2022 (AT) A 50316/2022

(51) Int. Cl. H02S 20/10; H02S 30/10; H02S 40/12

(52) U.S. Cl. CPC H02S 20/10; H02S 30/10; H02S 40/12

(57) ABSTRACT

A free-standing structure, on which solar panels for the conversion of radiant energy received from the sun into electrical energy are mounted. The structure has of a box-shaped panel carrier. The panel carrier stands on four posts, two southern posts and two northern posts. The posts are anchored in a foundation. PV panels are mounted on a southern side, on an east side, and on a west side of the panel carrier, wherein openings on a lower side and an upper side of the panel carrier are each closed by a storm grating that is permeable to air. A roof construction is positioned on the upper side of the panel carrier, which roof construction has PV panels facing south towards the sun, and of north side panels, wherein triangular openings provided on the east and west sides are each closed by a storm grating that is permeable to air.

The invention relates to a storm-proof construction for use at high altitudes, with which the efficiency of converting the sun's radiant energy into electrical energy by means of photovoltaics is improved in the winter months.

### BRIEF DESCRIPTION OF THE INVENTION

The conversion of solar energy radiated from the sun to the earth into electrical energy plays a key role in the transition of the energy system from fossil fuels to renewable energy sources. In an energy system that dispenses with fossil energy sources, electrical energy generated in wind turbines and photovoltaic (PV) systems is the central energy source. The documents KR 101665400 B1, CN 213043637 U and KR 102232231 B1 show state-of-the-art solar installations.

At the present time, the majority of PV systems are installed on the roofs of existing buildings, or on open spaces in the valley. The PV systems are oriented such that they produce the most energy in summer, and are less efficient in the winter months. As a result, in winter, when additional electrical energy is needed for the operation of heat pumps for heating purposes, there is an electrical energy gap that is currently filled by the burning of fossil fuels.

The present invention contributes to the closure of the energy gap in winter by designing a structure for the innovative installation of PV panels, which leads to a better energy yield from solar systems in the winter months.

Per square metre, approx. 1.3 kW of radiation from the sun on average hits a surface that is perpendicular to the solar radiation in both winter and summer. In our latitudes, the sun's rays hit the earth's surface at an average angle of approx. 15 degrees in the depths of winter. If the solar panels are positioned horizontally, the effective area under these conditions is approx. 25% of the solar panel, whereas if the solar panels are positioned vertically, the effective area in the depths of winter is approx. 97% of the solar panel. At an angle of 70°, the efficiency in the depths of winter is approx. 99%. An angle of 70° and steeper also ensures that incident snow slides off the panels.

In winter, there is thick fog in the valleys on many days, which absorbs the incoming sunlight. If the PV systems in the mountains are installed above the upper altitude limit of the fog, electrical energy is produced by PV systems in the mountains, even on days when the PV systems in the valley are not generating any power.

In the high mountains, there is a blanket of snow in winter from mid-November to mid-April. This snow cover reflects the incoming sun rays (the albedo effect) and leads to an improvement in the efficiency of a PV system whose PV panels are arranged above the snow cover. The measured increase in efficiency in winter due to the albedo effect is about 20% to 30%. The present invention makes use of the albedo radiation by mounting PV panels on a north-facing side that is inclined towards the snow cover.

There are a number of other reasons for installing PV systems in the mountains:
The solar energy supply is higher in the mountains than in the valley, since the solar radiation is less attenuated by the atmosphere, in particular by fog and aerosols, before it reaches the solar cells.
The lower temperatures in the mountains increase the efficiency of the solar cells.
The alpine pastures in the mountains are of less. agricultural and economic benefit than the areas in the valley that are needed for food production.

The major challenge when installing PV systems in the mountains is the control of the extreme winds. In an extreme case—during hurricane Kyrill in January 2007—wind speeds of up to 225 km/h occurred at the Konkordiahütte in Switzerland. In areas of the Eastern Alps that are not extremely exposed, wind speeds of more than 150 km/h do not occur. This wind speed of 150 km/h is taken as the reference value for the design of the structure.

A distinction is made between the following wind forces
(i) the pressure on the components
(ii) the pressure on the whole structure
(iii) the frictional forces that are caused by the wind.

Pressure on the components: The outer skin of the proposed structure for the conversion of radiant energy into electrical energy is largely formed by the solar panels. Solar panels that are commercially available can withstand an external pressure of up to 6,000 Pascal, which corresponds to a surface pressure at a wind speed of over 215 km/h, provided they are installed correctly. However, it is important that the wind pressure on the inner face of the PV panels, the internal pressure, does not damage the anchorage of the solar panel.

Pressure on the whole structure: The total pressure on a structure is essentially determined by the wind speed and the size of the area attacked by the wind, and results in a twisting moment that the foundation must withstand. As experience shows that the highest wind speed of a hurricane comes from the north-west, the twisting moment of the foundation in this direction must correspond to the twisting moment that is caused by a storm on the structure.

Frictional forces caused by the wind: The frictional forces depend on the roughness of the surfaces and the shape of the structure. A compact structure, in which the components are joined together in a flush manner (i.e. neither of the two components of a joint extends beyond the edge of the joint), forms a much smaller surface for the wind to attack than joints that have a projection.

The envisaged structure consists of a box-shaped panel carrier that stands on four posts. One of the two broad sides of the panel carrier faces south at an angle of approx. 70degrees. The PV panels can be mounted on the four sides of the panel carrier. At the edges of the structure, the surfaces are joined together in a flush manner.

The structure is designed such that a high energy yield is achieved from the solar radiation in winter. In the winter months, when the sun is on average about 20 degrees above the horizon, the 70 degree inclination of the panel carrier towards the south leads to an optimum energy yield from the PV panels mounted on the south side of the panel carrier. In winter, the PV panels mounted on the north side of the panel carrier, which are inclined at 20 degrees to the horizontal, convert the sun's rays that are reflected by the albedo effect of the snow into electrical energy.

A solar panel converts approx. 20% of the sun's radiant energy into electrical energy; the remaining 80% of the radiant energy is transferred to the panel in the form of heat. The panel heats itself and the surrounding air both inside and outside the panel carrier. The interior of the panel carrier, which is sealed on all sides, acts like a chimney so as to dissipate the heated air upwards. The cold air enters through a storm grating on the underside of the panel carrier, and by virtue of the heating rises upwards, where it flows outwards through other storm gratings. This design prevents the panels from heating up too much, which would lead to a reduction in the efficiency of the panels.

The design of the structure prevents a storm from hitting the rear face of a PV panel directly, and tearing it out of its anchorage. The storm gratings mounted on the top and bottom of the panel carrier on the one hand reduce the storm forces within the panel carrier, and on the other hand allow a flow of air to dissipate the heat generated in the PV panels.

In addition to the mechanical and thermal aspects discussed, ecological aspects were also taken into account in the design of the PV energy generation structure presented. It is envisaged that the supporting framework of the structure, which carries the solar panels, is built primarily from wood. Wood is a natural structural material that captures the CO₂ absorbed from the air. The use of wood in a structure stores the CO₂ over decades and thus serves as a natural CO₂ sink. The free space of approx. 3 m between the ground surface and the lower edge of the panel carrier 100 is partially filled with snow in winter. In summer, this open space can be used as pasture, or biodiversity can be supported by the planting of hedges.

In accordance with the invention, a roof construction is positioned on the panel carrier. This increases the energy yield further, and protects the interior of the panel carrier from rain, which increases the durability of a wooden structure.

### ENVIRONMENTAL SIGNIFICANCE OF THE INVENTION

Section 4 of the Austrian Federal Government's Renewable Energy Expansion Act (EAG) of 2021 envisages an increase in electricity generation from photovoltaics of 11 TWh by 2030. If one uses the distribution of the PV energy yield over the course of the year shown in Table 1 as a basis, 1 TWh of PV energy in the depths of winter would produce 150 GWh of electrical energy using conventional systems, compared to 300 GWh for the structure described.

TABLE 1
PV yield over the course of the year

| | PV on roofs, and free- | PV structure as |
|---|---|---|
| | standing PV systems in | described in the |
| Yield in % | the valley | mountains |
| Deep winter | 15% | 30% |
| (November, December, | | |
| January, February) | | |
| Transition period | 30% | 35% |
| (March, April, | | |
| August, September) | | |
| Summer | 55% | 35% |
| (May, June, | | |
| July, August) | | |

The generation of 150 GWh of electrical energy using gas causes emissions of about 75,000 t CO₂, which are avoided by the structure described.

If it is assumed that the PV electricity produced by the structure costs approximately the same in summer as in winter, and that, as an alternative, the winter electricity must be generated by converting green hydrogen, which is produced in summer, the winter electricity generation of this structure is more than 300% cheaper than the conversion of green hydrogen into electricity.

In Austria, there are about 10,000 km² of less productive areas in the mountains. If the structure described is built on less than 5% of these areas, which in the context of an environmental assessment for the production of solar energy are dedicated as solar parks, the entire winter electricity demand in Austria could be covered. As the structure utilises the third dimension, the surface areas of the solar park, that is to say, the alpine pastures, could continue to be farmed in the usual way.

### PRIOR ART

A literature search revealed the following patents and patent applications that relate to the vertical installation of solar panels.
D1: US 2019020300 A1 (IVERSEN BRIAN) 17 Jan. 2019 (17 Jan. 2019)
D2: CN 110719061 A (NANJING TANGYI INFORMATION TECH CO LTD) 21 Jan. 2020 (21 Jan. 2020)
D3: KR 20130123521 A (OH MYEONG GONG) 13 Nov. 2013 (13 Nov. 2013)
D4: JP 2014093383 A (HASEGAWA May 2014 TAKAHIRO) 19 May 2014 (19 May 2014)
D5: JP 2012019185 A (SONY CORP) 26 Jan. 2012 (26 Jan. 2012)
D6: U.S. Pat. No. 6,060,658 A (YOSHIDA HITOSHI, FUJII TAKASHI) 9 May 2000 (9 May 2000
D7: IT MI20120487 A1 (FERLA LODIGIANI LINO) 28 Sep. 2013 (28 Sep. 2013)
D8: JP 2015046540 A (SANYO ELECTRIC CO) 12 Mar. 2015 (12 Mar. 2015)

Document D1, which is considered to be a description of the closest prior art, depicts an arrangement of vertical outward-facing solar panels that are mounted one above the other along a post. From the many details of the figures of D1, it is clear that the wind issue is not taken into account in the proposed arrangement. The same is true for documents D2 to D5, which present mounting mechanisms for solar panels, but do not take into account the possible points of attack by a storm in the mountains. Nor do any of the documents D6 to D8 deal with the problem of mounting the solar panels in a wind-resistant manner, which is the subject of the present application.

The following documents were found during a further literature search:
D1′: JP 2007103806 A (NTT FACILITIES INC) 19 Apr. 2007
D2′: DE 202015100776 U1 (SOLARINVERT GMBH) 26 Feb. 2015
D3′: WO 2016042583 A1 (FRONTERRE ROBERTO) 24 Mar. 2016
D4′: DE 102019130374 A1 (WAS WIRTSCH MARTIN SCHROEDER GMBH) 1-11 12 May 2021
D5′: DE 20100511 U1 (WOLFRUM MARIO) 2 Aug. 2001
D6′: KR 101512093 B1 (OH MYEONG GONG) 14 Apr. 2015
D7′: WO 2021152466 A1 (DEWAN MOHAN RAJKUMAR)
D8′: KR 20180112358 A (LEE WAN HO) 12 Oct. 2018
D9′: WO 2013100283 A1 (OH MYEONG GONG) 4 Jul. 2013

D1′ describes a cylindrical device, a type of post, for the illumination of the environment with energy generated by PV panels-essentially a PV-powered street light. The wind-resistant device has a base, a battery, and a clock that can be used to switch the illumination on and off.

D2′ describes an energy tower for power generation, that is to say, a tower on whose sides PV panels are mounted, and on which a wind turbine with a vertical axis of rotation is installed for the generation of electricity.

D3′ describes a capped tower with PV panels mounted on its sides from top to bottom, and whose surface is inclined at an angle of between 1 degree and 65 degrees. The heat generated in the tower is dissipated via ventilation openings.

D4′ describes the installation of PV panels on an existing tower of a wind turbine facility.

D5′ also describes the arrangement of PV panels on the tower of an existing wind turbine facility.

D6′ describes a hybrid energy system in the form of a tower that comprises a wind turbine and PV panels for the generation of electricity.

D7′ also describes the arrangement of PV panels on the tower of a wind turbine facility, similar to D4′ and D5.

D8′ describes a hybrid energy system in the form of a tower for the generation of energy by means of PV panels and a wind turbine that supplies a building with energy.

D9′ also describes a hybrid energy system in the form of a tower for the generation of energy by means of PV panels and a wind turbine. The PV panels and the wind turbine are arranged at the upper end of the tower in the form of an umbrella.

None of the patent specifications cited describe the construction of a box-shaped PV system optimised for winter operation with a slender narrow side and an extended broad side, which is adapted to the flat trajectory of the sun in the high mountains, and uses the albedo effect, which tolerates storms of up to 150 km/h, and whose PV panels are arranged higher than the snow cover to be expected in the mountains in winter.

### EXPLANATION OF TERMS USED

The assumed meaning of important terms that are used in the following description is set out below.

Structure: Any infrastructure associated with an area of land as a result of human activity, regardless of its purpose or accessibility by humans. e.g. houses: electricity pylons, dams, roads, canals, bridges.

Deep winter: Deep winter comprises the months of November, December, January and February.

Panel carrier: A box-shaped component—a cuboid—on whose vertical sides PV panels can be mounted. The panel carrier has two broad sides, two narrow sides, an upper side and a lower side. The panel carrier stands on four posts that are anchored in a foundation.

PV panel: A flat component that contains the solar cells for the conversion of solar radiation into electrical energy. PV panels are commercially available in various dimensions. In the following example, PV panels with dimensions of 1 m×2 m and 1 m×1.4 m and a maximum electrical output (Wp) of approx. 500 and 350 watts respectively are used.

Solar angle: The angle 105 between the horizontal and the south-facing broad side of the panel carrier.

Flush connection of components: Two components are connected in a flush manner if neither component extends beyond the connecting edge.

Summer: Summer comprises the months of May, June, July and August.

Storm grating: A storm grating is a flat component (e.g. a mesh or a perforated plate) that on the one hand reduces the storm forces on the surface of the component facing away from the storm, and on the other hand allows air to flow through.

Transition period: The transition period comprises the months of September, October, March and April.

Roof projection: The part of a roof construction that extends beyond the body of the structure.

### BRIEF DESCRIPTION OF THE DRAWINGS

FIGS. 1a-c show elevations of a typical implementation of the structure from different points of the compass.

FIG. 2 shows the roof construction of the structure in elevation.

### DETAILED DESCRIPTION OF THE INVENTION

In what follows, one of the many possible implementations of the invention is described in detail, using the example of a structure with 44 solar panels. In this example, it is assumed that the majority of the PV panels have the dimensions of approx. 1 m width and approx. 2 m height, and have an output of 500 Wp. In an open, sunny location in the mountains, the annual energy yield of such a structure is estimated at approx. 19 MWh.

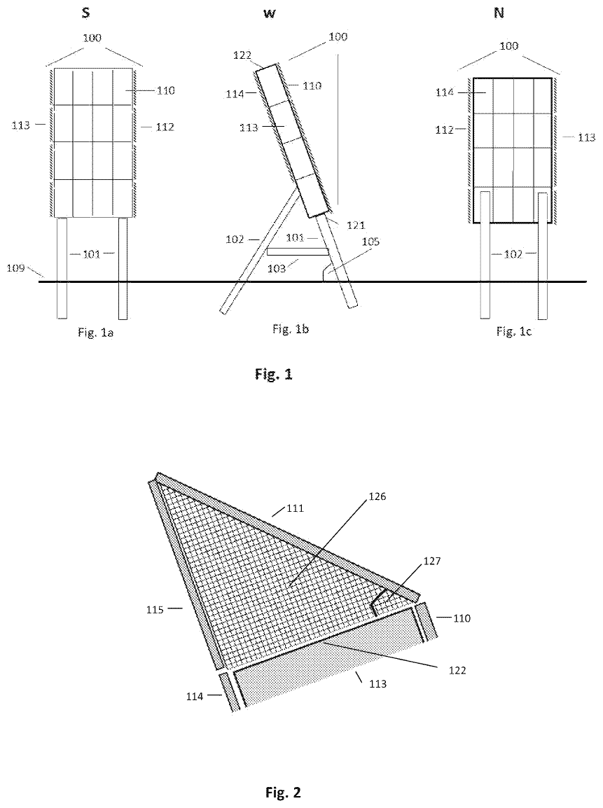

The free-standing structure in FIG. 1 for the conversion of the sun's radiant energy into electrical energy by means of photovoltaics consists of a box-shaped panel carrier 100, which stands on two south posts 101 and two north posts 102. The south-facing broad side of the panel carrier 100 is inclined towards the sun at a solar angle 105, which in the example is 70 degrees.

FIG. 1a shows the elevation of the structure as viewed from the south. Four rows, each of four PV panels 110, are mounted onto the panel carrier 100 on the south side. Four PV panels 113 can be seen on the west side of the panel carrier 100, and four PV panels 112 on the east side. The south posts 101 are anchored in a foundation in the ground 109.

FIG. 1b shows the elevation of the structure from the west. The four PV panels 113 are mounted onto the west side of the panel carrier 100. The two south posts 101 form the skeleton of the panel carrier 100, which is supported by the two north posts 102. In the example, the angle between the south post 101, which is inclined to the sun at a solar angle 105 of 70 degrees, and the corresponding north post 102, is 45 degrees. A storm grating is mounted on the lower side 121 of the panel carrier 100, and also on the upper side 122 of the panel carrier. On the one hand, the two storm gratings reduce the wind forces occurring in the interior of the panel carrier 100, and, on the other hand, allow an air flow to enter the interior of the panel carrier on the lower side (storm grating on the opening 121) and the heated air flow to exit on the upper side of the panel carrier 100 (storm grating on the opening 122). The connecting beam 103 increases the static strength of the design.

The view of the structure from the east is a mirror image of FIG. 1b.

In the depths of winter, the yield of the PV panels on the east and west sides of the structure is very limited, by virtue of the sun's trajectory. For this reason, a box shape with extended broad sides facing south (sun) and north (albedo), and a slender side facing east and west, is chosen for the structure. The narrow side facing west also reduces the surface area attacked by a storm coming from the west.

FIG. 1c shows the elevation of the structure from the northern direction. The northern broad side of the panel carrier 100 is inclined towards the surface of the ground at a solar angle 105. This ensures that the albedo reflections of the snow cover in winter are captured and transformed into electrical energy by the panels 114 on the north side. If the structure is erected in the valley, where little snow and therefore a low albedo effect is expected, the PV panels 114 can be omitted, and the north side of the structure can be planted with climbing plants.

All components of the structure are connected to each other without any projections, so that a storm cannot attack any unnecessary surface areas.

The posts 101 and 102, which support the panel carrier 100 and give the structure stability, can be made of wood, concrete, or steel, and are anchored in a concrete foundation, or a compacted gravel foundation.

FIG. 2 shows the view from the west of the roof construction, which is positioned on the upper side 122 of the panel carrier 100. The roof construction protects the interior of the panel carrier 100 from rain. On the south side the roof construction consists of four PV panels 111 with dimensions of 1×1.4 m, and on the north side it consists of two panels 115 mounted horizontally, with dimensions of 1×2 m, which form an extension to the north side of the panel carrier 100. In the example the angle 127 between the PV panels 111 and the upper side of the panel carrier 100 is 45 degrees. The roofing is connected to the panel carrier without any projections, so as to minimise the surface area that can be attacked by a storm.

There are two triangular openings 126 on the east and west sides of the roof construction; these are each covered with a storm grating. The thermal airflow from the interior of the panel carrier 100 normally flows through these openings 126. It should be emphasised that a storm attacking the structure from the west enters the interior of the panel carrier 100 with weakened force through the storm grating located in the west side, and leaves the interior through the storm grating located on the east side. A direct attack by a storm on the rear sides of the PV panels attached to the panel carrier 100, which could cause the PV panels to be torn from their anchorages, is ruled out by this roof construction.

Table 2 shows the annual energy production that can be expected from this example of a design, which is erected on a sunny site at a high altitude.

TABLE 2
Estimated energy production/year of the example of a structure.

| | Number of | Output | Full load | Energy yield/ |
|---|---|---|---|---|
| Side | PV panels | in kWp | hours/year | year in MWh |
| South | 20 | 9.4 | 1,400 | 13.2 |
| East | 4 + 4 | 4 | 800 | 3.2 |
| (West) | | | | |
| North | 16 | 8 | 350 | 2.8 |
| Total | | 21.4 | | 19.2 |

1. A free-standing structure, on which solar panels are mounted for the conversion of the radiant energy received from the sun into electrical energy wherein the structure comprises:
a box-shaped panel carrier with at least one broad side and at least one, in particular a slender, narrow side;
wherein a first broad side of the at least one broad side is inclined towards the sun at a solar angle facing south;
wherein a second broad side of the at least one broad side is inclined towards the snow cover or the ground at the solar angle facing north;
four posts where the panel carrier stands;
wherein each of the four posts have a minimum height;
wherein an inclination of two southern posts of the four posts corresponds to the solar angle;
wherein the solar angle in the surface parallel to the narrow side of the at least one narrow side of the panel carrier between a northern post and the corresponding southern post is about 45 degrees;
wherein the four posts are anchored in a foundation, and where;
a plurality of PV panels;
wherein at least one of the plurality of PV panels are attached on a south side of the panel carrier;
wherein at least one of the plurality of PV panels are attached on a east side;
wherein at least one of the plurality of PV panels are attached on a west side;
wherein PV panels are optionally attached on a north side;
wherein a first and second narrow side of the at least one narrow side and the first and second broad side of the at least one broad side of the panel carrier are connected to each other without projections;
wherein a lower side and an upper side of the panel carrier define at least one opening which are closed by a storm grating that is permeable to air;
wherein a roof construction is mounted on the upper side of the panel carrier, which consists of the plurality of PV panels facing south towards the sun, and of panels facing north, and where the triangular openings on the east and west sides are closed by a storm grating that is permeable to air.

2. The free-standing structure in accordance with claim 1, wherein each of the four posts are made of wood, concrete, or steel.

3. The free-standing structure in accordance with claim 1, wherein each of the four posts are anchored in a concrete foundation.

4. The free-standing structure in accordance with claim 1, wherein each of the four posts are anchored in a compacted gravel foundation.

5. The free-standing structure in accordance with claim 1, wherein the roofing roof construction is connected to the panel carrier without projections.

6. The free-standing structure in accordance with claim 1, wherein storm gratings are fitted over existing openings of the interior of the panel carrier, such that the wind pressure in the interior of the structure is reduced.

7. The free-standing structure in accordance with claim 1, wherein each one of the at least one broad side is at least 2 times as long as each one of the at least one narrow side.

8. The free-standing structure in accordance with claim 1, wherein the minimum height of each of the four posts is about 2 metres.

9. The free-standing structure in accordance with claim 1, wherein each one of the at least one broad sides are extending.

10. The free-standing structure in accordance with claim 1, wherein each one of the at least one narrow sides are slender.

11. The free-standing structure in accordance with claim 1, wherein the solar angle of the first broad side of the at least one broad side is 70 degrees facing south.

12. The free-standing structure in accordance with claim 1, wherein the solar angle of the second broad side of the at least one broad side is 70 degrees facing north.

13. The free-standing structure in accordance with claim 1, wherein the minimum height of each of the four posts is higher than the maximum snow cover that is expected in winter.

14. The free-standing structure in accordance with claim 1, wherein the minimum height of each of the four posts is about 2 metres.

15. The free-standing structure in accordance with claim 1, wherein each one of the at least one broad side is at least 3 times as long as each one of the at least one narrow side.

16. The free-standing structure in accordance with claim 1, wherein each one of the at least one broad side is at least 4 times as long as each one of the at least one narrow side.

17. The free-standing structure in accordance with claim 1, wherein each one of the at least one broad side is 4 times as long as each one of the at least one narrow side.
